(19) United States
(12) Patent Application Publication
(10) Pub. No.: US 2013/0228082 A1
(43) Pub. Date: Sep. 5, 2013

(54) ROLL PRESS APPARATUS

(71) Applicant: Hisashi Honjou, Yokohama-shi (JP)

(72) Inventor: Hisashi Honjou, Yokohama-shi (JP)

(21) Appl. No.: 13/883,886

(22) PCT Filed: Nov. 22, 2011
(86) PCT No.: PCT/JP2011/076885

§ 371 Date: May 7, 2013

(30) Foreign Application Priority Data
Nov. 24, 2010 (JP) 2010-261486

(51) Int. Cl. B30B 3/00; B21B 27/02; B30B 3/04

(52) U.S. Cl. CPC B30B 3/005; B30B 3/04; B21B 27/021
USPC 100/176; 492/2

(57) ABSTRACT

A roll press apparatus performs press working on objects to be shaped and a sheet, on which the objects to be treated are disposed in a gap between first and second rolls that are disposed parallel to each other so as to face each other. Crown shapes of the first and second rolls include inclined areas that are inclined with respect to rotation axes of the first and second rolls. The roll press apparatus includes a roll moving unit that moves the first and second rolls in opposite directions along rotation axis directions of the first and second rolls.

### TECHNICAL FIELD

The present invention relates to a roll press apparatus.

Priority is claimed on Japanese Patent Application No. 2010-261486, filed Nov. 24, 2010, the content of which is incorporated herein by reference.

### BACKGROUND ART

In the past, an apparatus, which performs rolling on a plate between a pair of rolls disposed so as to face each other as described in, for example, Patent Document 1, has been used as a rolling apparatus that performs rolling on a plate.

In such a rolling apparatus, a correction mechanism, which corrects the deflection of the rolls during the rolling, is installed and a method of making the thickness of a sheet uniform is used as described in, for example, Patent Document 1.

Further, in a rolling apparatus, as described in, for example, Patent Document 2, rolls of which crown shapes include areas having different inclination angles are disposed so as to face each other and the rolls, which are disposed so as to face each other, are moved in opposite directions along rotation axis directions so that the thickness of end portions of the sheet and the thickness of a middle portion of the sheet are adjusted.

### CITATION LIST

### Patent Document

[Patent Document 1] Japanese Unexamined Patent Application, First Publication No. H11-260356

[Patent Document 2] Japanese Unexamined Patent Application, First Publication No. 2002-11503

### Non-patent Literature

[Non-Patent Document 1] “Compression working roll facility business of electrode material sheet for secondary battery- high-precision roll press machine of HITACHI engineering service”, WATANABE KENICHI, industrial machinery magazine August, 2004, p65 to p67.

### SUMMARY OF INVENTION

### Technical Problem

Here, in recent years, there has been proposed a technique for manufacturing an electrode material sheet where electrode materials are disposed on a polar plate-base plate as a base material by a roll press apparatus in a process for manufacturing a secondary battery as described in Non-Patent Document 1.

Such a roll press apparatus is used to compress and shape the electrode materials disposed on the polar plate-base plate. The roll press apparatus is different from the above-mentioned rolling apparatus that deforms an object by rolling to make the object thin, but the uniformization of the thickness of the electrode material sheet is attempted by using the correction mechanism that corrects the deflection of the rolls as described in Non-Patent Document 1.

However, generally, when an electrode material sheet is manufactured by the roll press apparatus, a plurality of application films including electrode materials are arranged in multiple rows in the width direction of the polar plate-base plate and the plurality of application films arranged in multiple rows are subjected to press working between the rollers at one time so that the mass production of the electrode material sheet is possible.

Further, since the application films, which are applied in different rows, are formed by discharging application liquid from different nozzles, a deviation may occur in the thickness of the application films of the rows.

That is, in the roll press apparatus, a deviation is apt to occur in the thickness of the objects to be shaped (for example, application liquid).

Since one roll deflection correcting curve of which the size is changeable is provided in the correction mechanism that corrects the deflection of the rolls, it is difficult to shape all objects to be shaped into a desired thickness when a deviation occurs in the thickness of the objects to be shaped (for example, application film).

The invention has been made in consideration of the above-mentioned circumstances, and an object of the invention is to provide a roll press apparatus that is capable of shaping objects to be shaped into a desired thickness even though a deviation occurs in the thickness of the objects to be shaped provided on a sheet.

### Solution to Problem

According to an embodiment of the invention, in order to solve the above-mentioned circumstances, there is provided a roll press apparatus for performing press working on objects to be shaped, which are disposed on a sheet, for each sheet in a gap between first and second rolls that are disposed parallel to each other so as to face each other. Crown shapes of the first and second rolls include inclined areas that are inclined with respect to rotation axes of the first and second rolls. The roll press apparatus includes a roll moving unit that moves the first and second rolls in opposite directions along rotation axis directions of the first and second rolls.

According to the invention, it is possible to move the first and second rolls in the opposite directions along the rotation axis directions by the roll moving unit.

For this reason, if the crown shapes of the first and second rolls are not the shape of a straight line, it is possible to change a gap distance at different locations in the rotation axis direction by moving the first and second rolls in the opposite directions.

### Advantageous Effects of Invention

According to the invention, it is possible to shape objects to be shaped into a desired thickness even though a deviation occurs in the thickness of the objects to be shaped provided on a sheet.

### BRIEF DESCRIPTION OF DRAWINGS

FIG. 1 is a perspective view of a roll press apparatus according to an embodiment of the invention.

FIG. 2 is a schematic view showing a cross section taken along line II-II of FIG. 1.

FIG. 3A is a schematic view illustrating the operation of the roll press apparatus according to the embodiment of the invention.

FIG. 3B is a schematic view illustrating the operation of the roll press apparatus according to the embodiment of the invention.

FIG. 4 is a schematic view showing a modification of the roll press apparatus according to the embodiment of the invention.

### DESCRIPTION OF EMBODIMENTS

Hereinafter, an embodiment of a roll press apparatus according to the invention will be described referring to drawings. Here, the scale of each of the members is appropriately changed in the following drawings to show each of the members with a recognizable size.

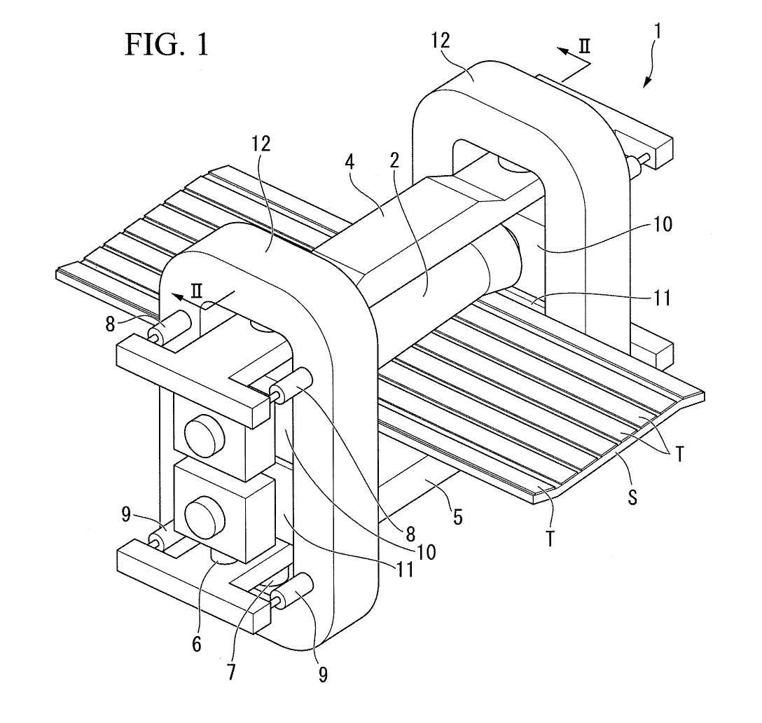

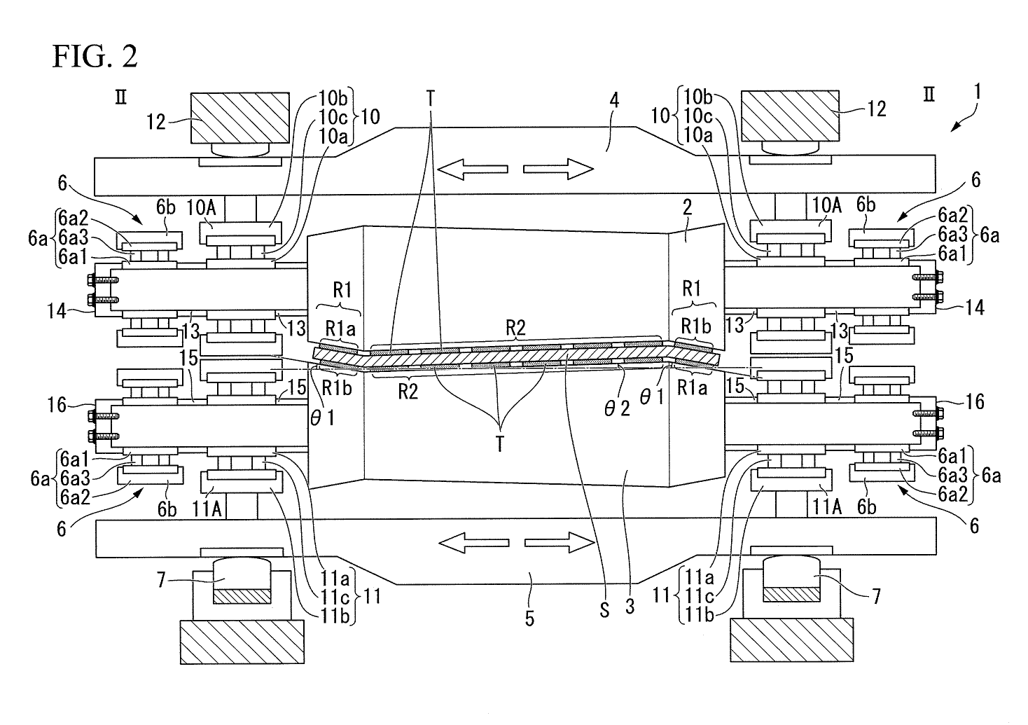

A roll press apparatus 1 of this embodiment is used to manufacture an electrode material sheet by performing press working and shaping a plurality of application films T (objects to be shaped), which are arranged in multiple rows on a polar plate-base plate S, and a sheet. As shown in FIGS. 1 and 2, the roll press apparatus 1 includes an upper roll 2 (first roll), a lower roll 3 (second roll), an upper shift beam 4 (first shift beam), a lower shift beam 5 (second shift beam), roll bending units 6, gap adjusting units 7, upper roll shift cylinders 8 (first cylinder), and lower roll shift cylinders 9 (second cylinder).

Here, the application film T is a material including an electrode material, and is a material that is slightly solidified by drying a predetermined amount of a binder of a fluid (application liquid), which includes the electrode material. For this reason, even though the application film T is applied to the lower surface of the polar plate-base plate S, the application film T adheres to the polar plate-base plate S without being separated from the polar plate-base plate S.

The upper roll 2 is used to shape the application films T, which are arranged on the polar plate-base plate S, by coming into contact with the upper side of the polar plate-base plate S. A rotation axis of the upper roll 2 is disposed along a horizontal direction that is orthogonal to the traveling direction of the polar plate-base plate S.

The upper roll 2 is disposed above the lower roll 3 and is disposed parallel to the lower roll 3 so as to face the lower roll 3.

The lower roll 3 is used to shape the application films T, which are arranged on the polar plate-base plate S, by coming into contact with the lower side of the polar plate-base plate S; and is disposed below the upper roll 2 so as to be parallel to the upper roll 2.

Here, the upper and lower rolls 2 and 3 are connected to a drive unit (not shown), and rotational power is transmitted to the upper and lower rolls 2 and 3 from the drive unit. Accordingly, the upper and lower rolls 2 and 3 are rotationally driven at the same speed in the directions that are opposite to each other along the traveling direction of the polar plate-base plate S.

Further, as shown in FIG. 2, in the roll press apparatus 1 of this embodiment, the crown shape of the upper roll 2 (the profile shape of a pressing surface when seen in the traveling direction of the polar plate-base plate S) is formed by end areas R1 and a middle area R2.

The end area R1a is an area that presses the end portion of the polar plate-base plate S and is provided on the left end side in the rotation axis direction of the upper roll 2 in FIG. 2. The end area R1b is an area that presses the end portion of the polar plate-base plate S and is provided on the right end side in the rotation axis direction of the upper roll 2 in FIG. 2.

Moreover, the two end areas R1a and R1b are inclined at a gap with respect to the rotation axis of the upper roll 2 by an inclination angle θ1. Specifically, the diameter of the end area R1a is reduced toward the left side in FIG. 2. The diameter of the end area R1b is increased toward the right side in FIG. 2.

Here, as shown in FIGS. 1 and 2, the roll press apparatus 1 of this embodiment performs press working on the polar plate-base plate S on which eight application films T have been arranged at regular intervals in a width direction. That is, a plurality of application films T are arranged in multiple rows in the width direction of the polar plate-base plate S, on which press working is performed by the roll press apparatus 1 of this embodiment.

Application liquid is discharged from nozzles to which application liquid is supplied from one supply pipe and which are disposed so as to correspond to the respective rows, so that the application films T are formed.

Further, in the roll press apparatus 1 of the this embodiment, the width of the end area R1a is set so that the end area R1a presses only the application film T positioned at the leftmost end of the polar plate-base plate S among the plurality of arranged application films T. Furthermore, the width of the end area R1b is set so that the end area R1b presses only the application film T positioned at the rightmost end of the polar plate-base plate S among the plurality of arranged application films T.

The middle area R2 is an area that presses the middle portion interposed between the end portions of the polar plate-base plate S pressed by the end areas R1a and R1b and is disposed so as to be interposed between the end area R1a and the end area R1b.

The middle area R2 is set at an inclination angle that is different from the inclination angles of the end areas R1a and R1b. Specifically, when the inclination directions of the end areas R1a and R1b are regarded as a positive direction, the middle area R2 is inclined in a negative direction and the inclination angle θ2 of the middle area R2 is set to be smaller than the inclination angle θ1 of the end areas R1a and R1b. That is, the diameter of the middle area R2 is reduced toward the right side in FIG. 2.

On the other hand, the crown shape of the lower roll 3 is set to the shape that is obtained by inverting the crown shape of the upper roll 2 in the vertical and lateral directions. That is, the crown shape of the upper roll 2 is the same as the crown shape of the lower roll 3. However, the end area R1a of the upper roll 2 is positioned at the left end in FIG. 2, but the end area R1a of the lower roll 3 is positioned at the right end in FIG. 2. Further, the end area R1b of the upper roll 2 is positioned at the right end in FIG. 2, but the end area R1b of the lower roll 3 is positioned at the left end in FIG. 2. That is, the lower roll 3 is inverted with respect to the upper roll 2.

As a result, since the lower roll 3 is disposed parallel to the upper roll 2, the crown shape of the lower roll 3 is formed by the end areas R1a and R1b and the middle area R2 like the crown shape of the upper roll 2 as shown in FIG. 2.

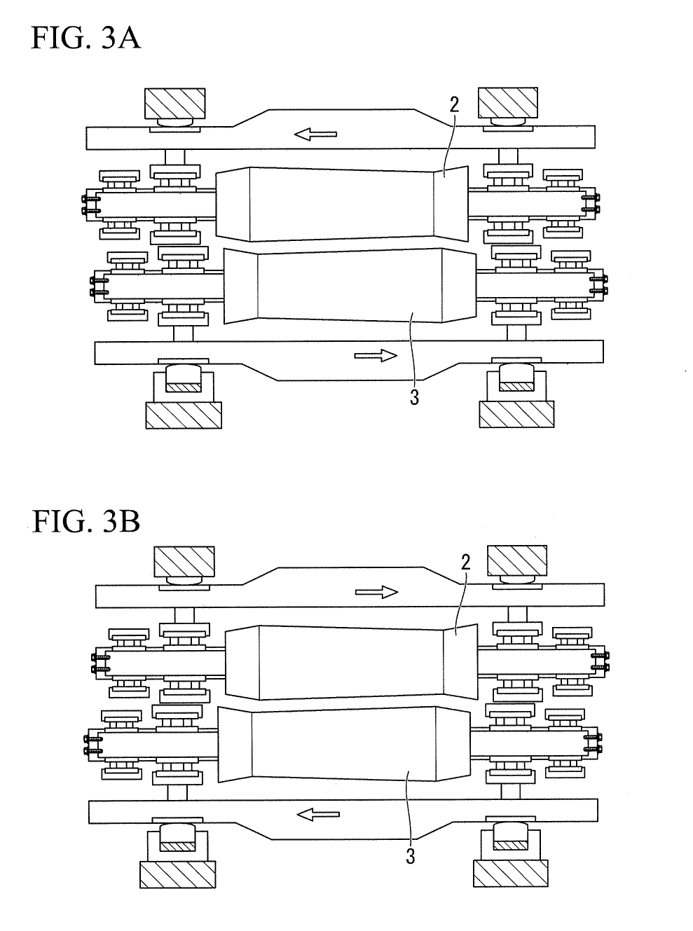

Since the crown shape of the upper roll 2 and the crown shape of the lower roll 3 are set as described above, the middle areas R2 become distant from each other (see FIG. 3A) when the upper and lower rolls 2 and 3 are moved in the opposite directions along the rotation axis direction so that the end areas R1a become distant from each other and the end areas R1b become close to each other (when the upper roll 2 is moved to the left side and the lower roll 3 is moved to the right side in FIG. 2). As a result, in the gap, gap distances of the areas, which shape the application films closest to the end portions among the application films T arranged in multiple rows, are reduced and a gap distance of the other area is increased (see FIG. 3A).

On the other hand, when the upper and lower rolls 2 and 3 are moved in the opposite directions along the rotation axis direction so that the end areas R1a become close to each other and the end areas R1b become distant from each other (when the upper roll 2 is moved to the right side and the lower roll 3 is moved to the left side in FIG. 2), the middle areas R2 become close to each other (see FIG. 3B). As a result, in the gap, gap distances of the areas, which shape the application films closest to the end portions among the application films T arranged in multiple rows, are increased and a gap distance of the other area is reduced (see FIG. 3B).

Here, the inclination angle θ2 of the middle area R2 is set to be smaller than the inclination angles θ1 of the end areas R1a and R1b in the roll press apparatus 1 of this embodiment. Accordingly, when the upper and lower rolls 2 and 3 are moved in the opposite directions, the rates of the change of the gap distances of the areas, which shape the application films closest to the end portions among the application films T arranged in multiple rows, are larger than that of the other area.

The upper shift beam 4 is disposed above the upper roll 2 and is disposed along the upper roll 2, and bearings 10 supporting the upper roll 2 are fixed to the upper shift beam 4.

The lower shift beam 5 is disposed below the lower roll 3 and is disposed along the lower roll 3, and bearings 11 supporting the lower roll 3 are fixed to the lower shift beam 5.

Further, as shown in FIG. 1, a pair of frames 12, which are disposed so as to face each other, are fixed to both end portions of the upper and lower rolls 2 and 3.

Furthermore, the bearings 10 and 11 are supported by the frames 12, so that the upper roll 2, the lower roll 3, the upper shift beam 4, and the lower shift beam 5 are supported.

Here, the bearings 10 and 11 are supported so as to be capable of independently sliding in the rotation axis directions of the upper and lower rolls 2 and 3.

Here, as shown in FIG. 2, the bearing 10 is fixed to the upper shift beam 4 with an axle box 10A interposed therebetween. The bearing 10 includes an inner race 10a that is fixed to the upper roll 2, an outer race 10b that is fixed to the axle box 10A, and rollers 10c that are interposed between the inner and outer races 10a and 10b.

Further, as shown in FIG. 2, the bearing 11 is fixed to the lower shift beam 5 with an axle box 11A interposed therebetween. The bearing 11 includes an inner race 11a that is fixed to the lower roll 3, an outer race 11b that is fixed to the axle box 11A, and rollers 11c that are interposed between the inner and outer races 11a and 11b.

The roll bending units 6 are used to correct the deflection of the upper roll 2 or the lower roll 3.

Furthermore, the roll bending units 6 are provided for each of the upper roll 2 and the lower roll 3 as shown in FIG. 2.

The roll bending units 6, which correct the deflection of the upper roll 2, are fixed to the upper shift beam 4 and, are connected to both ends of the upper roll 2 by bearings 6a. Further, the roll bending units 6 curve the upper roll 2 by raising and lowering both ends of the upper roll 2, which is supported by the bearings 10, to correct the deflection of the upper roll 2.

Here, as shown in FIG. 2, the bearing 6a is fixed to the upper shift beam 4 with an axle box 6b interposed therebetween. The bearing 6a includes an inner race 6a1 that is fixed to the upper roll 2, an outer race 6a2 that is fixed to the axle box 6b, and rollers 6a3 that are interposed between the inner and outer races 6a1 and 6a2.

Further, the roll bending units 6, which correct the deflection of the lower roll 3, are fixed to the lower shift beam 5 and, are connected to both ends of the upper roll 2 by bearings 6a. Furthermore, the roll bending units 6 curve the lower roll 3 by raising and lowering both ends of the lower roll 3, which is supported by the bearings 11, to correct the deflection of the lower roll 3.

Here, as shown in FIG. 2, the bearing 6a is fixed to the lower shift beam 5 with an axle box 6b interposed therebetween. The bearing 6a includes an inner race 6a1 that is fixed to the lower roll 3, an outer race 6a2 that is fixed to the axle box 6b, and rollers 6a3 that are interposed between the inner and outer races 6a1 and 6a2.

Here, as shown in FIG. 2, positioning sleeves 13 are installed between the inner race 10a of the bearing 10 and a roll body of the upper roll 2 and between the inner race 10a of the bearing 10 and the inner race 6a1 of the bearing 6a.

Moreover, positioning cups 14, which position the inner races 6a1 of the bearings 6a, are fastened to the end portions of the upper roll 2 by bolts.

The bearings 10 and the bearings 6a are positioned relative to the upper roll 2 by these positioning sleeves 13 and these positioning cups 14.

Further, as shown in FIG. 2, positioning sleeves 15 are installed between the inner race 11a of the bearing 11 and a roll body of the lower roll 3 and between the inner race 11a of the bearing 11 and the inner race 6a1 of the bearing 6a.

Furthermore, positioning cups 16, which position the inner races 6a1 of the bearings 6a, are fastened to the end portions of the lower roll 3 by bolts.

The bearings 11 and the bearings 6a are positioned relative to the lower roll 2 by these positioning sleeves 15 and these positioning cups 16.

The gap adjusting units 7 are used to adjust a gap distance between the upper and lower rolls 2 and 3, and are installed on the frames 12.

Further, the gap adjusting units 7 adjust a gap distance between the upper and lower rolls 2 and 3 by raising and lowering the lower shift beam 5.

The upper roll shift cylinders 8 are used to move the upper roll 2 in the rotation axis direction, are fixed to the frames 12, and are connected to the upper shift beam 4.

The upper roll shift cylinders 8 move the upper roll 2 in the rotation axis direction by pushing or pulling the upper shift beam 4 in the rotation axis direction of the upper roll 2.

The lower roll shift cylinders 9 are used to move the lower roll 3 in the rotation axis direction, are fixed to the frames 12, and are connected to the lower shift beam 5.

The lower roll shift cylinders 9 move the lower roll 3 in the rotation axis direction by pushing or pulling the lower shift beam 5 in the rotation axis direction of the lower roll 3.

Moreover, in the roll press apparatus 1 of this embodiment, the above-mentioned upper roll shift cylinders 8 and the above-mentioned lower roll shift cylinders 9 form a roll moving unit of the invention.

Further, the roll press apparatus 1 of this embodiment includes a controller (not shown), and moves the upper and lower rolls 2 and 3 in the directions, which are parallel to the rotation axis and opposite to each other, by the upper roll shift cylinders 8 and the lower roll shift cylinders 9 under the control of the controller.

In the roll press apparatus 1 of this embodiment having the above-mentioned structure, the polar plate-base plate S, on which the application films T have been arranged in multiple rows, is fed to the gap between the upper and lower rolls 2 and 3, and press working is performed on the application films T and the polar plate-base plate S in the gap by only a load that is applied by the upper and lower rolls 2 and 3.

Here, the deflections of the upper and lower rolls 2 and 3 are corrected by the roll bending units 6. Moreover, the overall adjustment of the gap distance is performed by the gap adjusting units 7.

Here, the application films T are discharged and applied to the polar plate-base plate S from a plurality of nozzles, which are arranged in the width direction of the polar plate-base plate S, on the upstream side of the roll press apparatus 1. In this case, since the application film T is supplied to all the nozzles from one pipe, internal pressure in the nozzles positioned at the ends among the plurality of nozzles is reduced. For this reason, the amount of the application film to be discharged from the nozzles positioned at the ends is apt to be smaller than that of the application film to be discharged from the other nozzles.

Further, when the thicknesses of the application films T positioned at the end portions among the application films T, which are arranged in multiple rows on the polar plate-base plate S, are reduced as compared to those of the other application films due to the reduction of the amount of the discharged application film T, the roll press apparatus 1 of this embodiment moves the upper and lower rolls 2 and 3 under the control of the controller so that the end areas R1a of the upper and lower rolls 2 and 3 become close to each other and the end areas R1b thereof become distant from each other (see FIG. 3B).

Meanwhile, the controller acquires information about the thickness of the application film T on the basis of the measurement result of a thickness measuring unit that is disposed on the downstream of the roll press apparatus 1 or an instruction that is sent from an operation unit operated by a worker.

Moreover, when the application films T are uniformly discharged from all the nozzles, the upper and lower rolls 2 and 3 become close to each other so that the gap distance of the end area R1 and the gap distance of the middle area R2 are equal to each other.

According to the above-mentioned roll press apparatus 1 of this embodiment, the upper and lower rolls 2 and 3 are configured to be capable of moving in the opposite directions along the rotation axis direction.

For this reason, if the crown shapes of the upper and lower rolls 2 and 3 are not a straight line as in this embodiment, it is possible to change the gap distance at different location in the rotation axis direction by moving the upper and lower rolls 2 and 3 in the opposite directions.

Accordingly, according to the roll press apparatus 1 of this embodiment, it is possible to shape the application films T into a desired thickness even though a deviation occurs in the thickness of the application films T arranged on the polar plate-base plate S.

In particular, the roll press apparatus 1 of this embodiment can flexibly change the thicknesses of the application films T in which a deviation in thickness most easily occurs and which are disposed at the end portions of the polar plate-base plate S, by the upper and lower rolls 2 and 3 that include the end areas R1 and the middle areas R2.

Further, the roll press apparatus 1 of this embodiment moves the upper roll 2 by moving the upper shift beam 4 and moves the lower roll 3 by moving the lower shift beam 5.

Actuators, which come into direct contact with the upper and lower rolls 2 and 3, may be used as the roll moving unit. However, in this case, a load is locally applied to part of the upper and lower rolls 2 and 3 when the upper and lower rolls 2 and 3 are moved. For this reason, there is a possibility that undesired deformation occurs on the upper and lower rolls 2 and 3.

In contrast, since the roll press apparatus 1 of this embodiment moves the upper roll 2 by moving the upper shift beam 4 and moves the lower roll 3 by moving the lower shift beam 5, it is possible to prevent a load from being locally applied to the upper and lower rolls 2 and 3 and to adjust the gap distance with high accuracy.

Moreover, the roll press apparatus 1 of this embodiment performs press working on the application films T by a load that is applied by the upper and lower rolls 2 and 3. For this reason, the roll press apparatus 1 is a simple and inexpensive roll press apparatus that does not need to include a backup roll to be installed when an additional load is required.

Further, since this structure is employed, it is possible to easily install the above-mentioned upper and lower shift beams 4 and 5 and to adjust a gap distance with high accuracy.

A preferred embodiment of the invention has been described above referring to the drawings, but the invention is not limited to the above-mentioned embodiment. The shapes, combination, and the like of the respective components shown in the above-mentioned embodiment are illustrative, and may be changed in various ways on the basis of design requirements without departing from the scope of the invention.

For example, the structure that shapes the application films T disposed on the polar plate-base plate S has been described in the above-mentioned embodiment.

However, the invention is not limited to this and may be applied to a press roll apparatus that disposes objects to be shaped other than the application films T on a sheet other than the polar plate-base plate S and performs press working on the objects.

Further, the invention may be applied to a roll press apparatus that shapes application films formed by applying some kind of application liquid onto a sheet, and may be used in a process for manufacturing an electrode material sheet that is used in, for example, a solar cell.

Furthermore, the structure where the application film T is formed of one linear member parallel to the traveling direction of the polar plate-base plate S has been described in the above-mentioned embodiment.

However, the application film to be shaped in the invention is not limited to this, and the application film may be divided into a plurality of pieces in the traveling direction of the polar plate-base plate S.

Further, the structure where the crown shapes of the upper and lower rolls 2 and 3 are a straight line has been described in the above-mentioned embodiment.

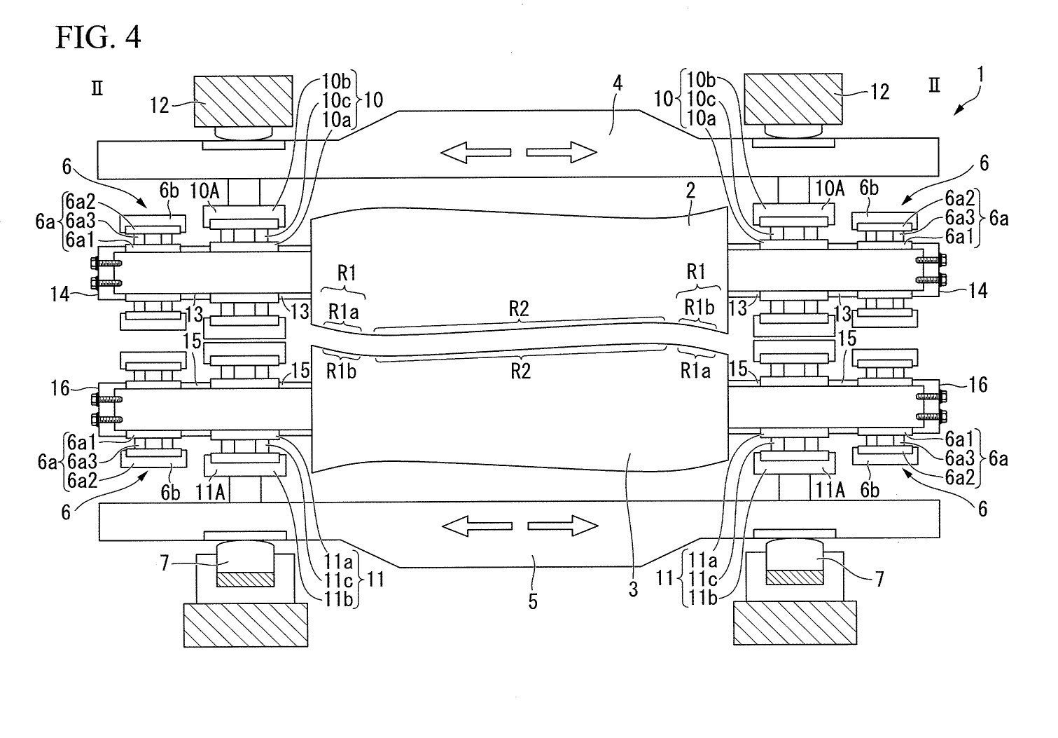

However, the invention is not limited to this, and a structure where end areas R1a and R1b and a middle area R2 are curved may be employed as shown in FIG. 4. If the rolls 2 and 3 are made round as described above, an effect for correcting and controlling the variation, which is caused by the bending of roll axes cores, of the distribution of a roll gap in the width direction of a plate by the shift of the rolls 2 and 3 is increased.

### INDUSTRIAL APPLICABILITY

According to the invention, it is possible to shape objects to be shaped into a desired thickness even though a deviation occurs in the thickness of the objects to be shaped that are arranged on a plate.

### REFERENCE SIGNS LIST

1: roll press apparatus
2: upper roll (first roll)
3: lower roll (second roll)
4: upper shift beam (first shift beam)
5: lower shift beam (second shift beam)
6: roll bending unit
7: gap adjusting unit
8: upper roll shift cylinder (first cylinder)
9: lower roll shift cylinder (second cylinder)
10, 11: bearing
12: frame
R1: end area
R2: middle area
S: polar plate-base plate (sheet)
T: application film (objects to be shaped)

1. A roll press apparatus for performing press working on objects to be shaped and a sheet, on which the objects to be shaped are disposed in a gap between a first roll and a second roll that are disposed parallel to each other so as to face each other,
wherein crown shapes of the first and second rolls include inclined areas that are inclined with respect to rotation axes of the first and second rolls,
the roll press apparatus comprising:
a roll moving unit that moves the first and second rolls in opposite directions along rotation axis directions of the first and second rolls.

2. The roll press apparatus according to claim 1,
wherein the roll moving unit includes a first shift beam to which bearings supporting the first roll are fixed and which are disposed along the first roll, a second shift beam to which bearings supporting the second roll are fixed and which are disposed along the second roll, a first cylinder that moves the first shift beam in the rotation axis direction of the first roll, and a second cylinder that moves the second shift beam in the rotation axis direction of the second roll.

3. The roll press apparatus according to claim 1,
wherein press working is performed on the objects to be shaped by only a load that is applied by the first and second rolls.

4. The roll press apparatus according to claim 1,
wherein the crown shape of the first roll includes end areas that press end portions of the sheet and are inclined with respect to the rotation axis of the first roll, and a middle area that presses a middle portion of the sheet interposed between the end portions and is set at an inclination angle different from inclination angles of the end areas, and
the crown shape of the second roll is set to a shape that is obtained by inverting the crown shape of the first roll in vertical and lateral directions.

5. The roll press apparatus according to claim 4,
wherein when the plurality of objects to be shaped are arranged in multiple rows in a width direction of the sheet, the end areas of the first roll press the objects to be shaped that are closest to the end portions among the plurality of arranged objects to be shaped.

6. The roll press apparatus according to claim 2,
wherein press working is performed on the objects to be shaped by only a load that is applied by the first and second rolls.

7. The roll press apparatus according to claim 2,
wherein the crown shape of the first roll includes end areas that press end portions of the sheet and are inclined with respect to the rotation axis of the first roll, and a middle area that presses a middle portion of the sheet interposed between the end portions and is set at an inclination angle different from inclination angles of the end areas, and
the crown shape of the second roll is set to a shape that is obtained by inverting the crown shape of the first roll in vertical and lateral directions.

8. The roll press apparatus according to claim 3,
wherein the crown shape of the first roll includes end areas that press end portions of the sheet and are inclined with respect to the rotation axis of the first roll, and a middle area that presses a middle portion of the sheet interposed between the end portions and is set at an inclination angle different from inclination angles of the end areas, and
the crown shape of the second roll is set to a shape that is obtained by inverting the crown shape of the first roll in vertical and lateral directions.

9. The roll press apparatus according to claim 6,
wherein the crown shape of the first roll includes end areas that press end portions of the sheet and are inclined with respect to the rotation axis of the first roll, and a middle area that presses a middle portion of the sheet interposed between the end portions and is set at an inclination angle different from inclination angles of the end areas, and
the crown shape of the second roll is set to a shape that is obtained by inverting the crown shape of the first roll in vertical and lateral directions.

10. The roll press apparatus according to claim 7,
wherein when the plurality of objects to be shaped are arranged in multiple rows in a width direction of the sheet, the end areas of the first roll press the objects to be shaped that are closest to the end portions among the plurality of arranged objects to be shaped.

11. The roll press apparatus according to claim 8,
wherein when the plurality of objects to be shaped are arranged in multiple rows in a width direction of the sheet, the end areas of the first roll press the objects to be shaped that are closest to the end portions among the plurality of arranged objects to be shaped.

12. The roll press apparatus according to claim 9,
wherein when the plurality of objects to be shaped are arranged in multiple rows in a width direction of the sheet, the end areas of the first roll press the objects to be shaped that are closest to the end portions among the plurality of arranged objects to be shaped.
